(19) United States
(12) Patent Application Publication
(10) Pub. No.: US 2025/0208696 A1
(43) Pub. Date: Jun. 26, 2025

(54) METHOD FOR OBJECT INTERACTION IN EXTENDED REALITY, DEVICE FOR PERFORMING THE SAME, AND EXTENDED REALITY DISPLAY SYSTEM INCLUDING THE DEVICE

(71) Applicant: Korea Advanced Institute of Science and Technology, Daejeon (KR)

(72) Inventors: Jinah Park, Daejeon (KR); Chanhyeok Lee, Daejeon (KR)

(73) Assignee: Korea Advanced Institute of Science and Technology, Daejeon (KR)

(21) Appl. No.: 18/966,279

(22) Filed: Dec. 3, 2024

(30) Foreign Application Priority Data
Dec. 26, 2023 (KR) 10-2023-0190849

(51) Int. Cl. G06F 3/01; G06F 3/04815; G06T 7/73; G06T 19/00

(52) U.S. Cl. CPC G06F 3/011; G06F 3/04815; G06T 7/73; G06T 19/006; G06T 2207/10028

(57) ABSTRACT

A device includes a first module configured to generate a point cloud of a target object based on a plurality of view vectors, a second module configured to generate a hand bubble based on a hand point and a hand point angle and a third module configured to generate an approximate sphere based on the point cloud and the hand bubble, and to determine a final interaction point of the target object based on the approximate sphere and a hand vector.

### PRIORITY STATEMENT

This application claims priority under 35 U.S.C. § 119 to Korean Patent Application No. 10-2023-0190849, filed on Dec. 26, 2023 in the Korean Intellectual Property Office KIPO, the contents of which are herein incorporated by reference in their entireties.

### BACKGROUND

### 1. Field

Embodiments of the present disclosure relate to the field of computer graphics, and more particularly, to a method for object interaction in extended reality, and device for performing the same.

### 2. Description of the Related Art

When user interacts with target object in extended reality, much research is being conducted to improve a precision of an interaction.

### SUMMARY

Embodiments of the present disclosure provide a method for object interaction in extended reality that improves the precision of interaction between user and target object in extended reality.

Embodiments of the present disclosure provide a device for performing the same.

Embodiments of the present disclosure provide an extended reality display system including the device.

According to embodiments, a device includes a first module which generates a point cloud of a target object based on a plurality of view vectors, a second module which generates a hand bubble based on a hand point and a hand point angle and a third module which generates an approximate sphere based on the point cloud and the hand bubble, and determines a final interaction point of the target object based on the approximate sphere and a hand vector.

In an embodiment, the point cloud may include a first point cloud of a front of the target object and a second point cloud of a behind of the target object.

In an embodiment, a density of the first point cloud may be higher than a density of the second point cloud.

In an embodiment, the point cloud may include a center point cloud generated based on a center view vector of the plurality of the view vectors and a peripheral point cloud generated based on a peripheral view vector of the plurality of the view vectors.

In an embodiment, a density of the center point cloud may be higher than a density of the peripheral point cloud.

In an embodiment, the hand bubble may have a sphere shape centered on the hand point.

In an embodiment, a size of the hand bubble may be changed.

In an embodiment, the size of the hand bubble may be changed based on the hand point angle such that the hand bubble has a radius longer than a distance between the hand point and the point cloud.

In an embodiment, the hand point angle may be changed based on a predict error.

In an embodiment, when the predict error is lower than a reference error, the hand point angle may be decreased.

In an embodiment, when a size of the target object decreases, the hand point angle may be decreased.

In an embodiment, when the predict error is higher than a reference error, the hand point angle may be increased.

In an embodiment, when a size of the target object increases, the hand point angle may be increased.

In an embodiment, the approximate sphere may be formed in an overlapping region where the hand bubble and the point cloud overlap.

In an embodiment, the approximate sphere may have a sphere shape reflecting an average curvature of the point cloud in the overlapping region.

In an embodiment, the hand vector may be a vector connecting a center of the approximate sphere and the hand point.

In an embodiment, the final interaction point may be a point at which the hand vector contacts the target object.

In an embodiment, the point cloud, the hand bubble and the approximate sphere may be changed as frame by frame.

In an embodiment, the final interaction point may be stored as frame by frame, and a set of the stored final interaction point is a region of interest.

According to embodiments, a method for object interaction in extended reality includes generating a point cloud of target object based on a plurality of view vectors, generating a hand bubble based on a hand point angle and a hand point, generating an approximate sphere based on the point cloud and the hand bubble and determining a final interaction point of the target object based on the approximate sphere and a hand vector.

In an embodiment, the point cloud may include a first point cloud of a front of the target object and a second point cloud of a behind of the target object.

In an embodiment, the hand bubble may have a sphere shape centered on the hand point. A size of the hand bubble may be changed based on the hand point angle such that the hand bubble has a radius longer than a distance between the hand point and the point cloud.

In an embodiment, the approximate sphere may be formed in an overlapping region where the hand bubble and the point cloud overlap. The approximate sphere may have a sphere shape reflecting an average curvature of the point cloud in the overlapping region.

In an embodiment, the hand vector may be a vector connecting a center of the approximate sphere and the hand point. The final interaction point may be a point at which the hand vector contacts the target object.

According to embodiments, an extended reality display system includes an extended reality display device which displays an extended reality, a rendering device which renders the extended reality and a device which performs an operation for an interaction in the extended reality. The device may include a first module which generates a point cloud of a target object based on a plurality of view vectors, a second module which generates a hand bubble based on a hand point and a hand point angle and a third module which generates an approximate sphere based on the point cloud and the hand bubble, and determines a final interaction point of the target object based on the approximate sphere and a hand vector.

In an embodiment, the point cloud may include a first point cloud of a front of the target object and a second point cloud of a behind of the target object.

In an embodiment, the hand bubble may have a sphere shape centered on the hand point. A size of the hand bubble may be changed based on the hand point angle such that the hand bubble has a radius longer than a distance between the hand point and the point cloud.

In an embodiment, the approximate sphere may be formed in an overlapping region where the hand bubble and the point cloud overlap. The approximate sphere may have a sphere shape reflecting an average curvature of the point cloud in the overlapping region.

In an embodiment, the hand vector may be a vector connecting a center of the approximate sphere and the hand point. The final interaction point may be a point at which the hand vector contacts the target object.

As described above, according to a method for object interaction in extended reality, a device for performing the same, and an extended reality display system including the device. the final interaction point may be determined by using the point cloud, the hand bubble, and the approximate sphere, the interaction precision between the user and the target object may be improved. Additionally, a direction of the hand vector and the direction of the normal vector at the final interaction point may be similar through the approximate sphere, so that the user may feel more comfortable than when interacting in a conventional extended reality environment.

### BRIEF DESCRIPTION OF THE DRAWINGS

FIG. 1 is a block diagram illustrating an extended reality display system according to embodiments of the present disclosure.

FIG. 2 is a block diagram illustrating a calculating device of FIG. 1.

FIG. 3 is a diagram illustrating an example of a point cloud generated by the calculating device of FIG. 2.

FIG. 4 is a diagram illustrating an example of a point cloud generated by the calculating device of FIG. 2.

FIG. 5 is a diagram illustrating an example of a hand bubble generated by the calculating device of FIG. 2.

FIG. 6 is a diagram illustrating an example of an approximate sphere generated by the calculating device of FIG. 2 and a final interaction point determined by the calculating device of FIG. 2.

FIG. 7 is a diagram illustrating an example of an approximate sphere generated by the calculating device of FIG. 2 and a final interaction point determined by the calculating device of FIG. 2.

FIG. 8 is a flowchart illustrating a method of determining a final interaction point by the calculating device of FIG. 1.

FIG. 9 is a diagram illustrating an example of a virtual reality display device of FIG. 1.

### DETAILED DESCRIPTION OF THE EMBODIMENTS

The present disclosure now will be described more fully hereinafter with reference to the accompanying drawings, in which embodiments of the present disclosure are shown. The present disclosure may, however, be embodied in many different forms and should not be construed as limited to the embodiments set forth herein.

Rather, these embodiments are provided so that this disclosure will be thorough and complete, and will fully convey the scope of the present disclosure to those skilled in the art. Like reference numerals refer to like elements throughout.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present disclosure.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the inventive concept as used herein.

Hereinafter, the present disclosure will be explained in detail with reference to the accompanying drawings.

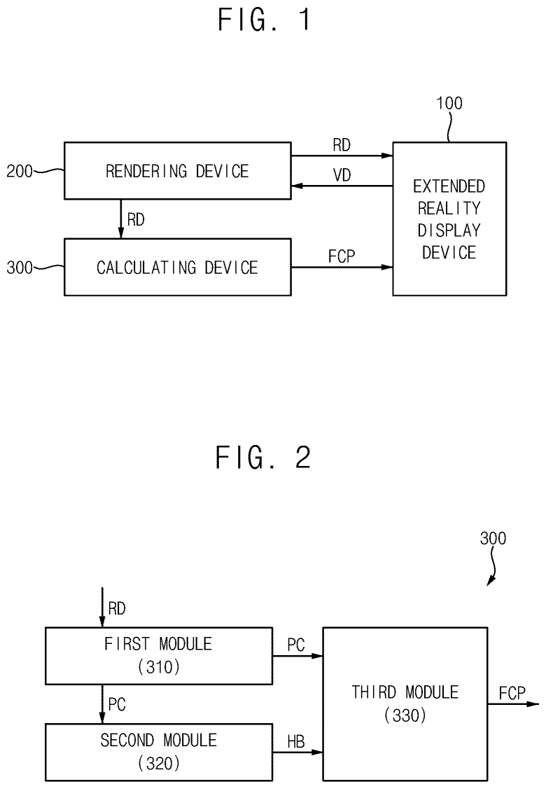

FIG. 1 is a block diagram illustrating an extended reality display system according to embodiments of the present disclosure.

Referring to FIG. 1, the extended reality display system may include an extended reality display device 100, a rendering device 200 and a calculating device 300.

In the present embodiment, the extended reality display device 100 may display an extended reality. For example, the extended reality may include a virtual reality, and augmented reality, a mixed reality, and etc. The extended reality display device 100 may apply virtual data VD to the rendering device 200 for displaying the extended reality. For example, the extended reality display device 100 may include a camera module. For example, the extended reality display device 100 may include virtual camera module. The virtual data VD may be generated based on the camera module and/or the virtual camera module. For example, the virtual data VD may include information of a location of a user and a direction which the user is looking. For example, the extended reality display device 100 may include a hand tracking module. The hand tracking module may determine a location information of hand of the user. In an embodiment, the hand tracking module may output the location information to the rendering device 200 and the calculating device 300. For example, the virtual data VD may be generated in real-time. In the present embodiment, the extended reality display device 100 may display the extended reality based on rendered data RD and a final interaction point FCP.

The rendering device 200 may receive the virtual data VD from the extended reality display device 100. The rendering device 200 may output the rendered data RD based on the virtual data VD. The rendering device may output the rendered data RD to the extended reality display device 100 and the calculating device 300. For example, the rendered data RD may include the virtual data VD.

The calculating device 300 may determine the final interaction point FCP based on the rendered data RD. The calculating device 300 may output the final interaction point FCP to the extended reality display device 100. In an embodiment, the rendering device 200 and the calculating device 300 may be integrated in the extended reality display device 100. In an embodiment, the rendering device 200 may be integrated in a first module 310 of FIG. 2. When the rendering device 300 is integrated in the first module 310 of FIG. 2, an efficiency may be improved. In an embodiment, the calculating device 300 may be a computing device.

In the present embodiment, through the calculating 300, an interaction accuracy of the extended reality display system may be improved. For example, the final interaction point FCP calculated from the calculating device 300 may improve an interaction accuracy between an interacting subject and an interacting object.

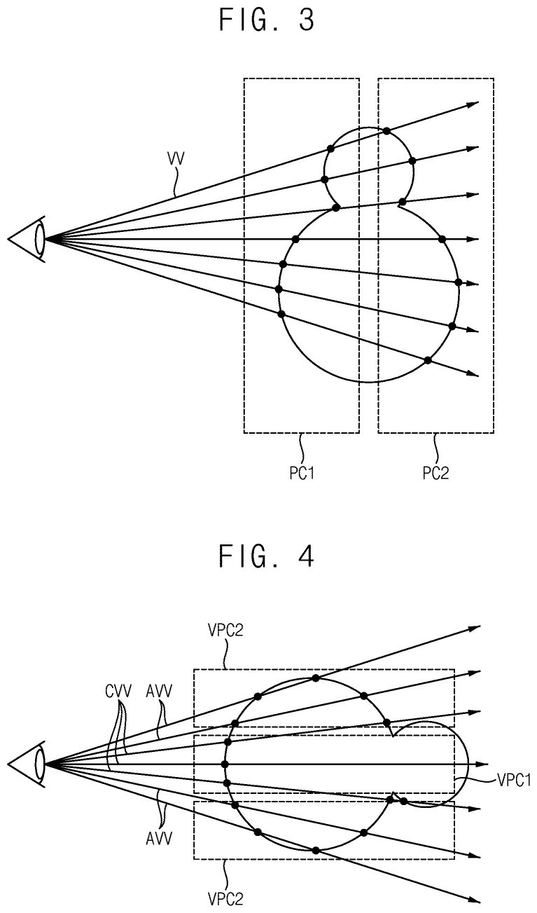

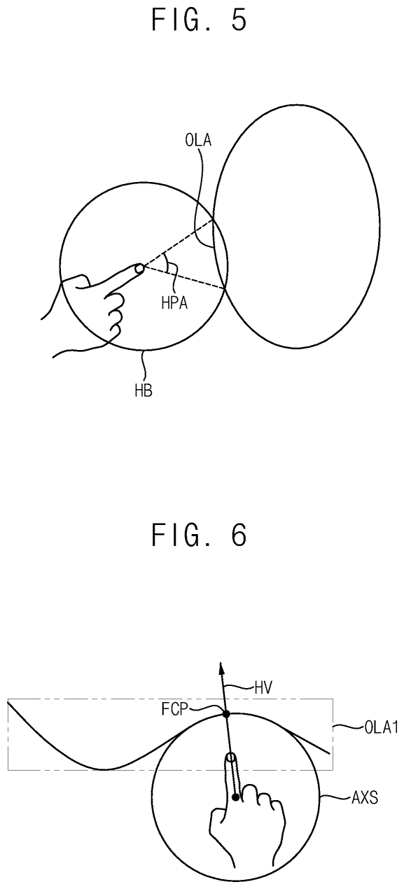

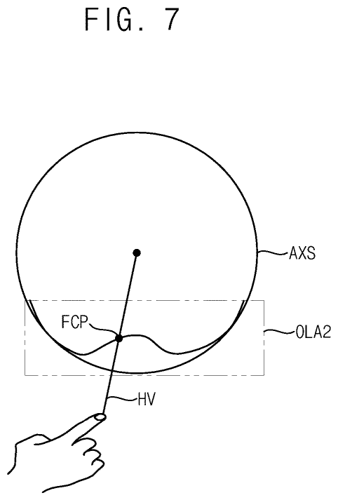

FIG. 2 is a block diagram illustrating a calculating device 300 of FIG. 1. FIG. 3 is a diagram illustrating an example of a point cloud PC generated by the calculating device 300 of FIG. 2. FIG. 4 is a diagram illustrating an example of a point cloud PC generated by the calculating device 300 of FIG. 2. FIG. 5 is a diagram illustrating an example of a hand bubble HB generated by the calculating device 300 of FIG. 2. FIG. 6 is a diagram illustrating an example of an approximate sphere AXS generated by the calculating device 300 of FIG. 2 and a final interaction point FCP determined by the calculating device 300 of FIG. 2. FIG. 7 is a diagram illustrating an example of an approximate sphere AXS generated by the calculating device 300 of FIG. 2 and a final interaction point FCP determined by the calculating device 300 of FIG. 2.

Referring to FIG. 2 to FIG. 7, the calculating device 300 may include the first module 310, a second module 320 and a third module 330.

In the present embodiment, the first module 310 may receive the rendered data RD. The first module 310 may generate a point cloud PC based on the rendered data RD and a plurality of view vector VV For example, the first module 310 may be called as a surface extraction module.

The point cloud PC may mean a set of 3D coordinates representing the surface of a virtual object by receiving the location and direction of the virtual object, the location and direction of the virtual camera, etc. as inputs. The view vectors VV may be defined based on the user's gaze. A first point cloud PC1 may be generated in front of a target object viewed by the user's gaze. A second point cloud PC2 may be generated in the back (e.g., behind) of the target object viewed by the user's gaze. In the present embodiment, since the point cloud PC may be generated by using the view vectors VV, the second point cloud PC2 may also be generated in the back of the target object. Accordingly, the user may interact with the back of the target object. A density of the first point cloud PC1 may be higher than a density of the second point cloud PC2.

The point cloud PC may include a center point cloud VPC1 and a peripheral point cloud VPC2. The view vectors VV may include center view vectors CVV and peripheral view vectors AVV. A vector corresponding to a center of the user's gaze among the view vectors VV may be defined as the central view vectors CVV. A vector corresponding to a periphery of the user's gaze among the view vectors VV may be defined as the peripheral view vectors AVV. The center point cloud VPC1 may be generated based on the center view vectors CVV. The peripheral point cloud VPC2 may be generated based on the peripheral view vectors AVV. A density of the center point cloud VPC1 may be higher than a density of the peripheral point cloud VPC2. Since the density of the center point cloud VPC1 may be high, a high density point cloud PC may be generated at a location where the user's gaze mainly remains. Accordingly, the precision of the interaction between the user and the target object may be improved.

In the present embodiment, the second module 320 may receive the point cloud PC. The second module 320 may generate a hand bubble HB based on the point cloud PC, a hand point HP and a hand point angle HPA. For example, the second module 320 may be called as a bubble filter module.

The hand point HP may be defined as a point corresponding to the user's hand. For example, the hand point HP may be a point corresponding to the user's index finger. However, the present inventive concept is not limited to a location of the hand point HP. For example, the hand point HP may be changed by the user.

The hand point angle HPA may be an angle set by the user based on the hand point HP as the center. The hand point angle HPA may be changed based on an predict error. The predict error may mean a predicted value of an error range between the interaction location of the target object and the location of the target object. For example, when the predict error is lower than a reference error, the hand point angle HPA may be decreased. The reference error may be defined as an error range set by the user. For example, the reference error may be defined as an error range corresponding to a reference size. For example, when the predict error is higher than the reference error, the hand point angle HPA may be increased. For example, when a size of the target object is smaller than the reference size, the hand point angle HPA may be decreased. For example, when the size of the target object decreases, the hand point angle HPA may be decreased. For example, when the size of the target object is larger than the reference size, the hand point angle HPA may be increased. For example, when the size of the target object increases, the hand point angle HPA may be increased. Since the hand point angle HPA may be changed based on at least one of target object and the expected error, the precision of the interaction between the user and the target object may be improved.

In an embodiment, the hand point angle HPA may be changed based on an initial overlapping region. For example, an initial hand point angle may mean an angle before the hand point angle HPA is changed. The initial overlapping region may mean a region where the initial hand bubble generated based on the initial hand point angle and the point cloud PC overlap. For example, the hand point angle HPA may be changed based on the size of the initial overlap region.

The hand bubble HB may have a sphere shape centered on the hand point HP. A size of the hand bubble HB may be changed. For example, the size of the hand bubble HB may be changed based on the hand point angle HPA, such that the hand bubble HB has a radius longer than a distance between the hand point HP and the point cloud PC. For example, the hand point angle HPA may be fixed while the length of the radius of the hand bubble HB may be changed.

In the present embodiment, the third module 330 may receive the point cloud PC and the hand bubble HB. The third module 330 may generate the approximate sphere AXS based on the point cloud PC and the hand bubble 1B. The third module 330 may determine the final interaction point FCP of the target object based on the approximation sphere AXS and a hand vector HV For example, the third module 330 may be called as a projection module.

The approximation sphere AXS may be formed in an overlapping region OLA at which the point cloud PC and the hand bubble HB overlap. For example, the approximation sphere AXS may have a sphere shape reflecting an average curvature of the point cloud PC in the overlapping region OLA. Although the overlapping region OLA is drawn as a line in FIG. 5, the overlapping region OLA may be defined as a three-dimensional region having curvature. As illustrated in FIG. 6, the approximate sphere AXS reflecting the average curvature of the point cloud PC may be generated in a first overlapping region OLA1. Additionally, as illustrated in FIG. 7, the approximate sphere AXS reflecting the average curvature of the point cloud PC may be generated in a second overlapping area OLA2.

The hand vector HV may be defined as a vector connecting a center of the approximate sphere AXS and the hand point HP. For example, the hand vector HV may be defined as a vector having the hand point HP as a starting point and the center of the approximate sphere AXS as an ending point. For example, the hand vector HV may be defined as a vector having the center of the approximate sphere AXS as a starting point and a direction toward the hand point HP. For example, the hand vector HV may be defined as a vector having the hand point HP as a starting point and a direction toward the center of the approximate sphere AXS.

The final interaction point FCP may be a point where the hand vector HV contacts the target object. As illustrated in FIG. 6, the point where the point cloud PC and the hand vector HV contact in the first overlapping region OLA1 may be the final interaction point FCP. Additionally, as illustrated in FIG. 7, a point where the point cloud PC and the hand vector HV contact in the second overlapping region OLA2 may be the final interaction point FCP.

Since the calculating device 300 according to the present embodiment may determine the final interaction point FCP by using the point cloud PC, the hand bubble HB, and the approximate sphere AXS, the interaction precision between the user and the target object may be improved.

In the present embodiment, a direction of the hand vector HV and the direction of the normal vector at the final interaction point FCP may be similar through the approximate sphere AXS. Accordingly, when the user interacts with the target object through the calculating device 300, the user may feel more comfortable than when interacting in a conventional extended reality environment.

In the present embodiment, the point cloud PC, the hand bubble HB, and the approximate sphere AXS may be changed frame by frame. Accordingly, the precision of the interaction between the user and the target object may be improved.

In the present embodiment, the final interaction point FCP may be stored on a frame basis. Additionally, a set of the stored final interaction points may be stored as a region of interest. By using the region of interest, the extended reality displayed by the extended reality display device 100 may be changed.

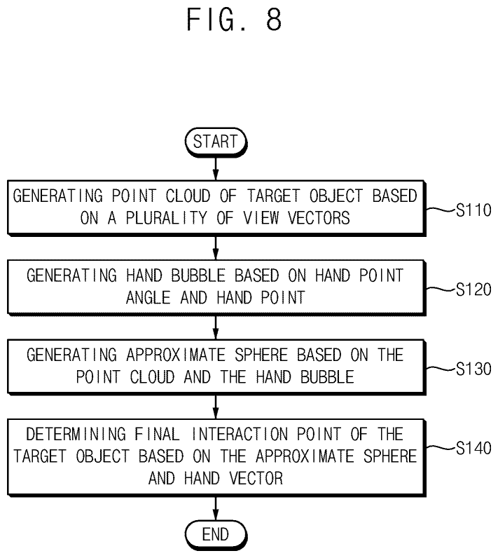

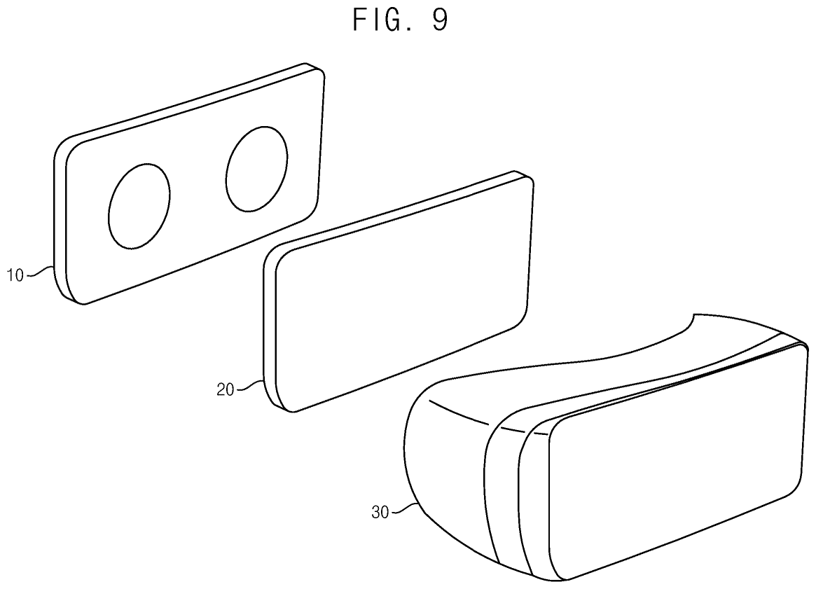

FIG. 8 is a flowchart illustrating a method of determining a final interaction point by the calculating device of FIG. 1.

Referring to FIG. 8, for determining a final interaction point, the calculating device may generate a point cloud of a target object based on a plurality of view vectors. (S110) After generating the point cloud, the calculating device may generate a hand bubble based on a hand point angle and a hand point. (S120) After generating the hand bubble, the calculating device may generate an approximate sphere based on the point cloud and the hand bubble. (S130) After generating the approximate sphere, the calculating device may determine the final interaction point of the target object based on the approximate sphere and a hand vector. (S140)

Since the calculating device according to the present embodiment may determine the final interaction point FCP by using the point cloud PC, the hand bubble HB, and the approximate sphere AXS, the interaction precision between the user and the target object may be improved.

In the present embodiment, a direction of the hand vector HV and the direction of the normal vector at the final interaction point FCP may be similar through the approximate sphere AXS. Accordingly, when the user interacts with the target object through the calculating device 300, the user may feel more comfortable than when interacting in a conventional extended reality environment.

FIG. 9 is a diagram illustrating an example of a virtual reality display device 100 of FIG. 1.

Referring to FIG. 9, the virtual reality display device may include a lens unit 10, a display apparatus 20 and a housing 30. The display apparatus 20 is disposed adjacent to the lens unit 10. The housing 30 may receive the lens unit 10 and the display apparatus 20. Although the lens unit 10 and the display apparatus 20 are received in a first side of the housing 30 in FIG. 11, the present inventive concept may not be limited thereto. Alternatively, the lens unit 10 may be received in a first side of the housing 30 and the display apparatus may be received in a second side of the housing 30. When the lens unit 10 and the display apparatus 20 are received in the housing 30 in opposite sides, the housing 30 may have a transmission area to transmit a light.

For example, the virtual reality display system may be a head mounted display system which is wearable on a head of a user. Although not shown in figures, the virtual reality display system may further include a head band to fix the virtual reality display system on the head of the user.

Alternatively, the virtual reality display system may have the form of smart glasses implemented in the shape of glasses.

In an embodiment, the extended reality display system may be utilized in field of games, smart factories, interior design, and art.

For example, the field of games may include a chess game. Through the extended reality display system, the precision of interaction between the user and the target object may be improved. Accordingly, when the user performs the chess game, a more satisfactory experience may be provided through the extended reality display system.

For example, when the extended reality display system is utilized in the field of smart factories, the precision of interaction between the user and the target object may be improved through the extended reality display system, so that the environment to which the smart factory field is applied may be more easily controlled.

For example, when the extended reality display system is utilized in the field of interior design, the precision of interaction between the user and the target object may be improved through the extended reality display system, so that when the user performs interior design within an extended reality space, the position of furniture, etc. may be adjusted more precisely.

For example, when the extended reality display system is utilized in the art field, the precision of interaction between the user and the target object may be improved through the extended reality display system, so that when the user draws a picture within the extended reality space, a more precise picture may be drawn.

Additionally, the extended reality display system may be utilized in various fields other than the game field, the smart factory field, the interior field, and the art field.

The present inventive concept may be applied to a calculating device and an extended reality display system including the same. For example, the calculating device of the present inventive concept may be utilized in an extended reality device, a virtual reality device, an augmented reality device, a mixed reality device, etc.

The foregoing is illustrative of the present inventive concept and is not to be construed as limiting thereof. Although a few embodiments of the present inventive concept have been described, those skilled in the art will readily appreciate that many modifications are possible in the embodiments without materially departing from the novel teachings and advantages of the present inventive concept. Accordingly, all such modifications are intended to be included within the scope of the present inventive concept as defined in the claims. In the claims, means-plus-function clauses are intended to cover the structures described herein as performing the recited function and not only structural equivalents but also equivalent structures. Therefore, it is to be understood that the foregoing is illustrative of the present inventive concept and is not to be construed as limited to the specific embodiments disclosed, and that modifications to the disclosed embodiments, as well as other embodiments, are intended to be included within the scope of the appended claims. The present inventive concept is defined by the following claims, with equivalents of the claims to be included therein.

What is claimed is:

1. A device comprising:
a first module which generates a point cloud of a target object based on a plurality of view vectors;
a second module which generates a hand bubble based on a hand point and a hand point angle; and
a third module which generates an approximate sphere based on the point cloud and the hand bubble, and determines a final interaction point of the target object based on the approximate sphere and a hand vector.

2. The device of claim 1, wherein the point cloud includes a first point cloud of a front of the target object and a second point cloud of a behind of the target object.

3. The device of claim 2, wherein a density of the first point cloud is higher than a density of the second point cloud.

4. The device of claim 1, wherein the point cloud includes a center point cloud generated based on a center view vector of the plurality of the view vectors and a peripheral point cloud generated based on a peripheral view vector of the plurality of the view vectors.

5. The device of claim 4, wherein a density of the center point cloud is higher than a density of the peripheral point cloud.

6. The device of claim 1, wherein the hand bubble has a sphere shape centered on the hand point.

7. The device of claim 6, wherein a size of the hand bubble is changed.

8. The device of claim 7, wherein the size of the hand bubble is changed based on the hand point angle such that the hand bubble has a radius longer than a distance between the hand point and the point cloud.

9. The device of claim 1, wherein the hand point angle is changed based on a predict error.

10. The device of claim 9, wherein when the predict error is lower than a reference error, the hand point angle is decreased.

11. The device of claim 9, wherein when a size of the target object decreases, the hand point angle is decreased.

12. The device of claim 9, wherein when the predict error is higher than a reference error, the hand point angle is increased.

13. The device of claim 9, wherein when a size of the target object increases, the hand point angle is increased.

14. The device of claim 1, wherein the approximate sphere is formed in an overlapping region where the hand bubble and the point cloud overlap.

15. The device of claim 14, wherein the approximate sphere has a sphere shape reflecting an average curvature of the point cloud in the overlapping region.

16. The device of claim 1, wherein the hand vector is a vector connecting a center of the approximate sphere and the hand point.

17. The device of claim 16, wherein the final interaction point is a point at which the hand vector contacts the target object.

18. A method for object interaction in extended reality comprising:
generating a point cloud of target object based on a plurality of view vectors;
generating a hand bubble based on a hand point angle and a hand point;
generating an approximate sphere based on the point cloud and the hand bubble; and
determining a final interaction point of the target object based on the approximate sphere and a hand vector.

19. The method of claim 18, wherein the point cloud includes a first point cloud of a front of the target object and a second point cloud of a behind of the target object.

20. An extended reality display system comprising:
an extended reality display device which displays an extended reality;
a rendering device which renders the extended reality; and
a device which performs an operation for an interaction in the extended reality, wherein the device includes:
a first module which generates a point cloud of a target object based on a plurality of view vectors;
a second module which generates a hand bubble based on a hand point and a hand point angle; and
a third module which generates an approximate sphere based on the point cloud and the hand bubble, and determines a final interaction point of the target object based on the approximate sphere and a hand vector.
